(19) United States
(12) Patent Application Publication
(10) Pub. No.: US 2010/0071006 A1
(43) Pub. Date: Mar. 18, 2010

(54) BROADCAST RECEIVING APPARATUS AND METHOD FOR PROVIDING AND RECEIVING AN EDITED BROADCAST THEREOF

(75) Inventors: Ji-hyun PARK, Seoul (KR); Dae-gu KIM, Gwacheon-si (KR); Il-kown KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/536,180

(22) Filed: Aug. 5, 2009

(30) Foreign Application Priority Data
Sep. 12, 2008 (KR) 10-2008-0090427

(51) Int. Cl. H04N 5/445; H04N 7/173

(52) U.S. Cl. 725/50; 725/114

(57) ABSTRACT

A broadcast receiving apparatus which receives a received broadcast and a method for providing an edited broadcast using the same are provided. A broadcast receiving apparatus includes a broadcast reception unit which receives a received broadcast; an input unit which receives an editing command for editing the received broadcast; and a controlling unit which edits the received broadcast based on the editing command, and transmits the edited broadcast to an external server via a network.

### CROSS-REFERENCE TO RELATED APPLICATIONS

This application claims priority under 35 U.S.C. §119 from Korean Patent Application No. 10-2008-0090427, filed on Sep. 12, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a broadcast receiving apparatus and a method for providing and receiving edited broadcast thereof, and more particularly, to a broadcast receiving apparatus which receives a broadcast and a method for providing and receiving an edited broadcast thereof.

2. Description of the Related Art

Generally, public broadcasts are produced and transmitted by broadcasting stations, and viewers may select one from among a plurality of public broadcasts and consume the selected public broadcast.

Although the broadcasting stations produce content to provide to viewers, the range and quantity of content produced is bound to be limited in that broadcasting stations producing public broadcasts are few in number. Additionally, since the broadcasting stations produce content using professionals and specialized equipment, which is difficult for the general public to produce, it is difficult for the viewers to actively participate in the production of content, and viewers merely view received public broadcasts.

With the development and popularization of the Internet, content is being produced not only by Internet operators and content providers but also by the general public. Such content produced by the general public is referred to as User Created Content (UCC), and is part of the culture representing the 21^{st} century. Such content produced by the general public is being provided to a plurality of viewers through private broadcasts.

However, as such private broadcasts may produce content without utilizing professionals or specialized equipment, the content may be less technical than that of public broadcasts. For example, private broadcasts may merely transmit an image input through a camera, or music.

Therefore, there is a need to satisfy a user who desires to produce his or her own content having both the special techniques of public broadcasts and the personality of private broadcasts.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

According to an exemplary aspect of the present invention, there is provided a broadcast receiving apparatus including a broadcast reception unit which receives a received broadcast; an input unit which receives an editing command for editing the received broadcast; and a controlling unit which generates an edited broadcast by editing the received broadcast based on the editing command, and which transmits the edited broadcast to an external server via a network.

The edited broadcast may be generated by adding editing data to the received broadcast.

The editing data may comprise data generated before the broadcast is received or may comprise data generated after the broadcast is received.

The editing data may comprise a list of users accessing the network to view the edited broadcast.

The editing data may comprise data input by the users accessing the network to view the edited broadcast.

The editing data may be at least one of video data, audio data, and text data.

The edited broadcast may include at least one option which is set corresponding to the received broadcast.

The at least one option may comprise least one of whether the broadcast is publicly viewable, a limit in a number of viewers of the edited broadcast, and a time at which the edited broadcast is transmitted over the network.

The controlling unit may add information, wherein the information comprises a time at which the edited broadcast is transmitted, to an electronic program guide (EPG) which is received through the broadcast reception unit, and transmit the EPG comprising the time of the edited broadcast to the external server.

The broadcast receiving apparatus may additionally include a storage unit which stores at least one of the received broadcast, the data generated before the received broadcast is received, and the data input by users accessing the network.

According to another exemplary aspect of the present invention, there is provided a broadcast receiving apparatus including a broadcast reception unit which receives a broadcast from a broadcasting station; a network interface which receives an edited broadcast from an external server; and a controlling unit which displays at least one of the received broadcast and the edited broadcast based on a command for selecting a channel.

The controlling unit may allot the received broadcast to a first predetermined channel and the edited broadcast to a second predetermined channel, and output an output broadcast corresponding to a selected channel based on the command for selecting the channel.

The broadcast receiving apparatus may further include a display which displays at least one of the received broadcast and the edited broadcast, wherein the controlling unit may add information, wherein the information comprises a time at which the edited broadcast is transmitted, to an electronic program guide (EPG) which is received together with the received broadcast, and display the EPG having the information regarding the time of the edited broadcast on the display.

According to another exemplary aspect of the present invention, there is provided a method for providing an edited broadcast using a broadcast receiving apparatus, the method including receiving a broadcast; receiving a command for editing the received broadcast; generating an edited broadcast by editing the received broadcast based on the editing command; and transmitting the edited broadcast to an external server via a network.

The generating the edited broadcast may include adding editing data to the received broadcast.

The editing data may include data which is generated before the broadcast is received or generated after the broadcast is received.

The editing data may include a list of users accessing the network to view the edited broadcast.

The editing data may include data input by the users accessing the network to view the edited broadcast.

The editing data may be at least one of video data, audio data, and text data.

The edited broadcast may include at least one option which is set corresponding to the received broadcast.

The at least one option may comprise whether the broadcast is publicly viewable, a limit in a number of viewers of the edited broadcast, and a time at which the edited broadcast is transmitted over the network.

The editing operation may add information, the information comprising a time at which the edited broadcast is transmitted, to an electronic program guide (EPG) which is received together with the edited broadcast.

The method for providing an edited broadcast may additionally include storing at least one of the received broadcast, the data generated before the received broadcast is received, and the data input by users accessing the network.

According to another exemplary aspect of the present invention, there is provided a method for receiving an edited broadcast using a broadcast receiving apparatus, the method including receiving a received broadcast from a broadcasting station; receiving an edited broadcast from an external server through a network; receiving a command for selecting a channel; and outputting at least one of the received broadcast and the edited broadcast based on the command for selecting the channel.

The method may further include allotting the received broadcast to a first predetermined channel, and allotting the edited broadcast to a second predetermined channel; and receiving the command for selecting the channel, wherein the outputting includes outputting an output broadcast corresponding to the selected channel based on the command for selecting the channel.

The method may further include if a command for outputting an electronic program guide (EPG) is received, adding information, comprising a time at which the edited broadcast is transmitted, to the EPG received together with the received broadcast.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view of a broadcast editing system according to an exemplary embodiment of the present invention;

FIG. 2 is a block diagram of a digital television (DTV) according to an exemplary embodiment of the present invention;

FIGS. 3A and 3B are views showing an edited broadcast according to an exemplary embodiment of the present invention;

FIGS. 4A and 4B are views showing an electronic program guide (EPG) to which information regarding broadcast time of an edited broadcast is added according to an exemplary embodiment of the present invention; and

FIG. 5 is a flowchart provided to explain a method for providing an edited broadcast according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are merely provided to assist in a comprehensive understanding of the invention. That is, the present invention can be carried out without those specifically defined matters, and is thus not limited to the exemplary embodiments disclosed herein. Also, well-known functions or constructions are not described in detail since they would obscure the invention with unnecessary detail.

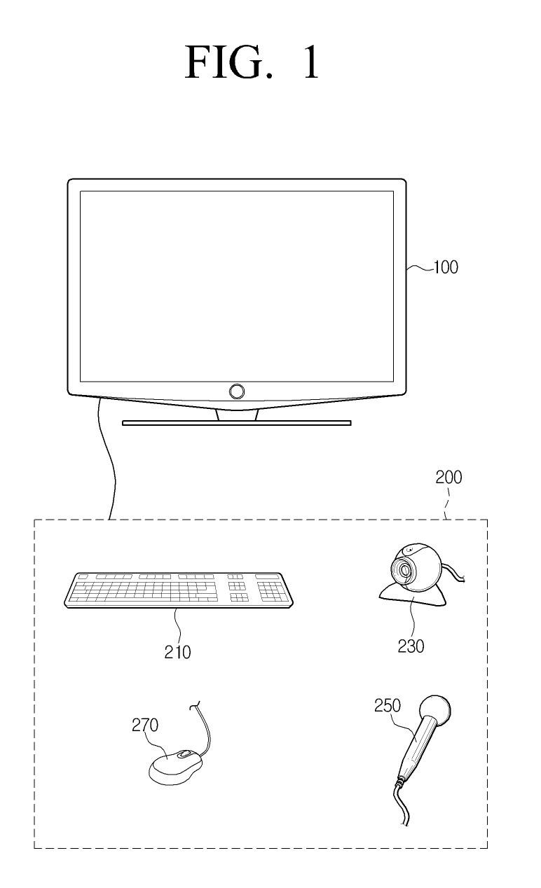

FIG. 1 is a view of a broadcast editing system according to an exemplary embodiment of the present invention. Referring to FIG. 1, a broadcast editing system is implemented using a digital television (DTV) 100 and an editor 200.

The DTV 100 receives broadcasts over wire or wirelessly (referred to below as “public broadcasts”). A user using the DTV 100 (referred to below as “the user”) may edit public broadcasts using the editor 200. The editor 200 receives a command for editing a public broadcast from a user and transmits the received command to the DTV 100.

The DTV 100 transmits the public broadcast edited by the editor 200 (referred to below as “the edited broadcast”) to a viewer desiring to view the edited broadcast (referred to below as “the viewer”) via a network, e.g., the Internet. It should be noted while the term Internet is used herein, it is merely an example of a network. Similarly, exemplary embodiments of the present invention can equally be applied to any network, such as a local area network (LAN).

Since this exemplary embodiment of the present invention provides a viewer with the edited broadcast reflecting the personality of a user, the edited broadcast may be a private broadcast.

Public broadcasts are distinct from private broadcasts in that public broadcasts are produced by a content provider or a broadcasting station using professionals and specialized equipment, whereas private broadcasts are produced by members of the general public without using specialized equipment.

The editor 200 comprises a keyboard 210, a camcorder 230, a microphone 250, and a mouse 270.

The keyboard 210 is a type of input apparatus which is used to generate and input text data such as letters, numerals, or signs. A user may edit public broadcasts by adding text data such as letters, numerals, or signs using the keyboard 210. For example, a user may receive a public broadcast of a soccer match, and edit the broadcast by adding a text commentary input using the keyboard 210.

The camcorder 230 is a type of input apparatus which is used to generate image data such as still images or motion images. A user may edit public broadcast by adding video data using the camcorder 230. For example, a user may receive a public broadcast of a soccer match, and edit the broadcast by adding a video of a commentator.

The microphone 250 is a type of input apparatus which is used to generate audio data. A user may edit a public broadcast by adding audio data using the microphone 250. For example, a user may receive a public broadcast of a soccer match, and edit the broadcast by adding a voice commentary of a commentator.

The mouse 270 is a type of subsidiary input apparatus which is used to assist with the generation of audio, video, or text data. A user may use the mouse 270 to edit a public broadcast by adding an audio, video or text which is generated through the keyboard 210, the camcorder 230, or the microphone 250.

The DTV 100 receives a public broadcast from a broadcasting station, generates an edited broadcast as a result of a user editing the received public broadcast using the editor 200, and transmits the generated edited broadcast to a server, e.g., an external server via the Internet. A viewer receives the edited broadcast from the external server via the Internet, and views the received broadcast.

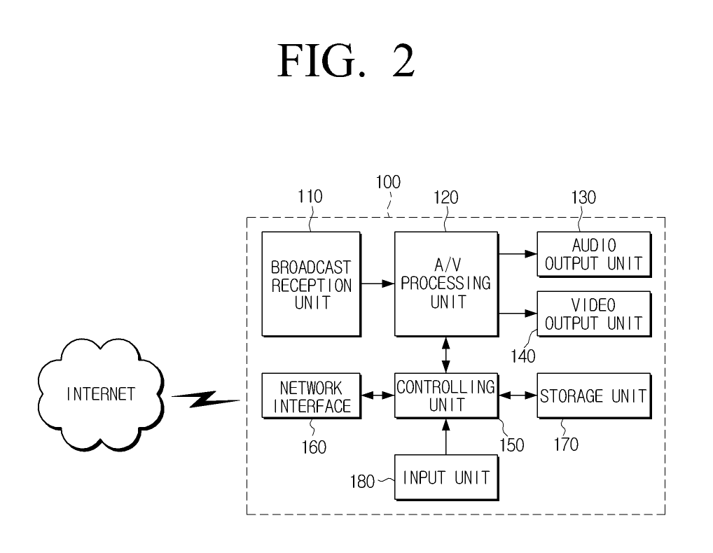

The structure of the DTV 100 will be explained with reference to FIG. 2. FIG. 2 is a block diagram of the DTV 100 according to an exemplary embodiment of the present invention.

Referring to FIG. 2, the DTV 100 comprises a broadcast reception unit 110, an audio/video (A/V) processing unit 120, an audio output unit 130, a video output unit 140, a controlling unit 150, a network interface 160, a storage unit 170, and an input unit 180.

The broadcast reception unit 110 receives a public broadcast from a broadcasting station or satellite over wire or wirelessly and demodulates the received public broadcast.

The A/V processing unit 120 processes an audio signal and a video signal input from the broadcast reception unit 110 by performing video decoding, video scaling, audio decoding, or the like. The A/V processing unit 120 transmits the audio signal to the audio output unit 130 and transmits the video signal to the video output unit 140.

The A/V processing unit 120 generates a graphical user interface (GUI) to provide to a user and adds the generated GUI to a decoded video.

The audio output unit 130 outputs audio received from the A/V processing unit 120 through a speaker, and the video output unit 140 displays video received from the A/V processing unit 120 on a display, or outputs the video to an external apparatus such as an external display connected to an external output terminal.

The network interface 160 operates as a connection path which connects the DTV 100 to the external server. Specifically, the network interface 160 connects the DTV 100 to the external server over a public network such as the Internet or a telephone connection. The network interface 160 transmits the edited broadcast to the external server via the Internet and receives broadcasts edited by other broadcast receiving apparatuses from the external server via the Internet.

The edited broadcast may be a public broadcast to which audio, video, or text data are added.

The data may be data which are generated after the public broadcast is received from a broadcasting station, or data which are generated before the public broadcast is received from a broadcasting station. If the data are used whenever a public broadcast is edited, the data may be generated in advance and stored, and if the data are not always used, the data may be generated after the public broadcast is received.

The previously generated data are stored in the storage unit 170, which will be explained below, and the data generated after the public broadcast is received are input from the editor 200 through the input unit 180, which will also be explained below.

The data comprises a list of users who access the Internet in order to view the edited broadcast and data which are input by the users.

For example, if users A, B, C, and D access the Internet, the edited broadcast may be a public broadcast on which a list of the users A, B, C, and D accessing the Internet is added. Alternatively, if users A, B, C, and D chat with each other, the edited broadcast may be a public broadcast on which text data input by the users A, B, C, and D are added.

Such data regarding the list of users and text data input by the users are transmitted to the network interface 160.

The data comprise options set for a public broadcast, and thus the edited broadcast having the options may be a private broadcast. The DTV 100 transmits the edited broadcast to a network such as the Internet as a private broadcast.

The options comprise options regarding whether to allow the edited broadcast to be made public, the number of users allowed to view the edited broadcast, and the time at which the edited broadcast is transmitted via a network, e.g., the Internet.

The DTV 100 receives a public broadcast through the broadcast reception unit 110, and regenerates the public broadcast as a private broadcast by setting the options for the public broadcast, and uploads the regenerated private broadcast to the Internet through the network interface 160.

The input unit 180 receives an editing command received through the editor 200 from a user. The input unit 180 transmits the editing command received through the editor 200 to the controlling unit 150.

The storage unit 170 stores programs to drive the DTV 100, and may be implemented as a memory or a hard disc drive (HDD). The storage unit 170 stores public broadcasts received from the broadcast reception unit 110, data received through the network interface 160, and data input through the input unit 180.

The controlling unit 150 controls operations of the broadcast reception unit 110, the A/V processing unit 120, the network interface 160, and the storage unit 170 according to user commands received through the input unit 180.

The controlling unit 150 controls the broadcast reception unit 110 to receive a broadcast signal of a public broadcast provided over a channel selected by a user. The controlling unit 150 controls the A/V processing unit 120 so that the broadcast signal of the received public broadcast is demodulated and the broadcast signal of the demodulated public broadcast is decoded and processed. In doing so, the user may receive and view a public broadcast through the DTV 100.

The controlling unit 150 controls the network interface 150 so that data regarding users accessing the Internet are received and the edited broadcast is transmitted to the users via the Internet.

The controlling unit 150 controls the storage unit 170 to store data required to generate the edited broadcast.

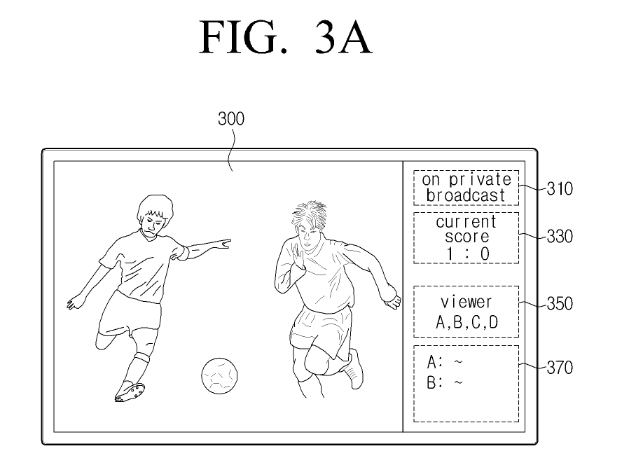

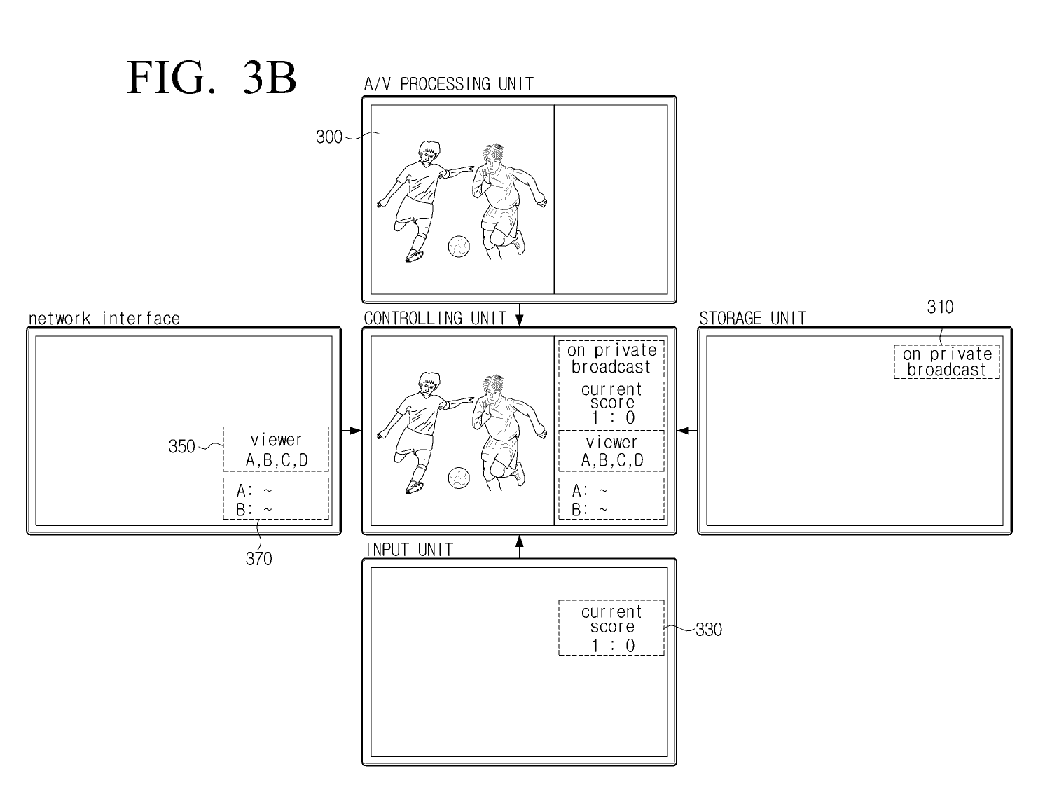

FIGS. 3A and 3B are views showing an edited broadcast according to an exemplary embodiment of the present invention. FIG. 3A is a view showing a screen of an edited broadcast, and FIG. 3B is a view showing the process of generating the edited broadcast.

Referring to FIG. 3A, a public broadcast 300 received through the broadcast reception unit 110 is displayed on a left portion of a screen of the DTV 100, and various data 310, 330, 350, 370 are displayed on a right portion thereof.

The DTV 100 displays the edited broadcast combining the public broadcast 300 and the various data 310, 330, 350, 370 on the screen. The user transmits the edited broadcast to viewers accessing the Internet.

The various data 310, 330, 350, 370 comprise first data 310 which are pre-stored in the storage unit 170 before the public broadcast 300 is received, second data 330 which are generated after the public broadcast 300 is received, third data 350 which are related to a list of users accessing the Internet to view the edited broadcast, and fourth data 370 which are input by users accessing the Internet to view the edited broadcast.

Herein below, the process of generating the various data 310, 330, 350, 370 will be explained with reference to FIG. 3B.

Referring to FIG. 3B, the controlling unit 150 receives the public broadcast 300 and the various data 310, 330, 350, 370 from the A/V processing unit 120, the network interface 160, the storage unit 170, and the input unit 180, respectively.

Specifically, the controlling unit 150 receives from the A/V processing unit 120 the public broadcast 300 of which a signal is processed, and receives from the network interface 160 the third data 350 which are related to a list of users accessing the Internet to view the edited broadcast and the fourth data 370 which are input by users accessing the Internet to view the edited broadcast.

The controlling unit 150 receives from the storage unit 170 the first data 310 which are pre-stored in the storage unit 170 before the public broadcast 300 is received, and receives from the editor 200 through the input unit 180 the second data 330 which are generated after the public broadcast 300 is received and the data regarding the option settings.

The controlling unit 150 generates an edited broadcast by combining the received public broadcast 300 and the various data 310, 330, 350, 370, and transmits the generated edited broadcast to viewers through the network interface 160.

By doing so, a user may edit high quality content provided from a public broadcast to be a private broadcast displaying the user's personality, and may provide the edited broadcast to viewers.

An edited broadcast is generated by adding text or video data to a public broadcast consisting of a video in this exemplary embodiment of the present invention, but this is merely an exemplary embodiment for convenience of description. Alternatively, a public broadcast consisting of audio may be used or audio may be added to a public broadcast so as to generate an edited broadcast.

As described above, the DTV 100 generates an edited broadcast by combining the received public broadcast 300 and the various data 310, 330, 350, 370, and transmits the generated edited broadcast to viewers accessing a network, such as the Internet, through the network interface 160.

In this situation, the DTV 100 may transmit information regarding the time at which the edited broadcast is broadcast (referred to below as “the edited broadcast time information”) together with or separately from the edited broadcast. The DTV 100 may add edited broadcast time information to an electronic program guide (EPG) which provides information regarding the time at which the public broadcast is broadcast, and transmits the EPG having the edited broadcast time information together with the public broadcast time information to users accessing the Internet.

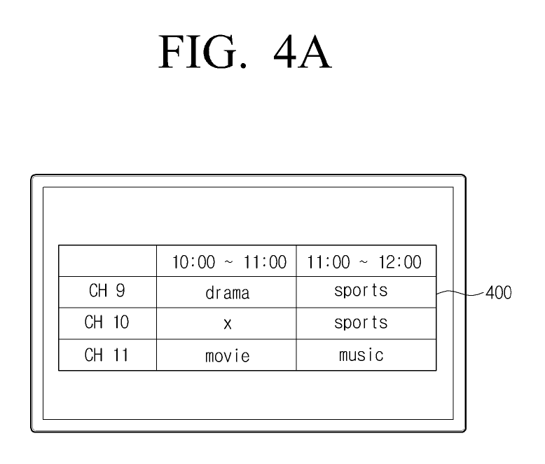

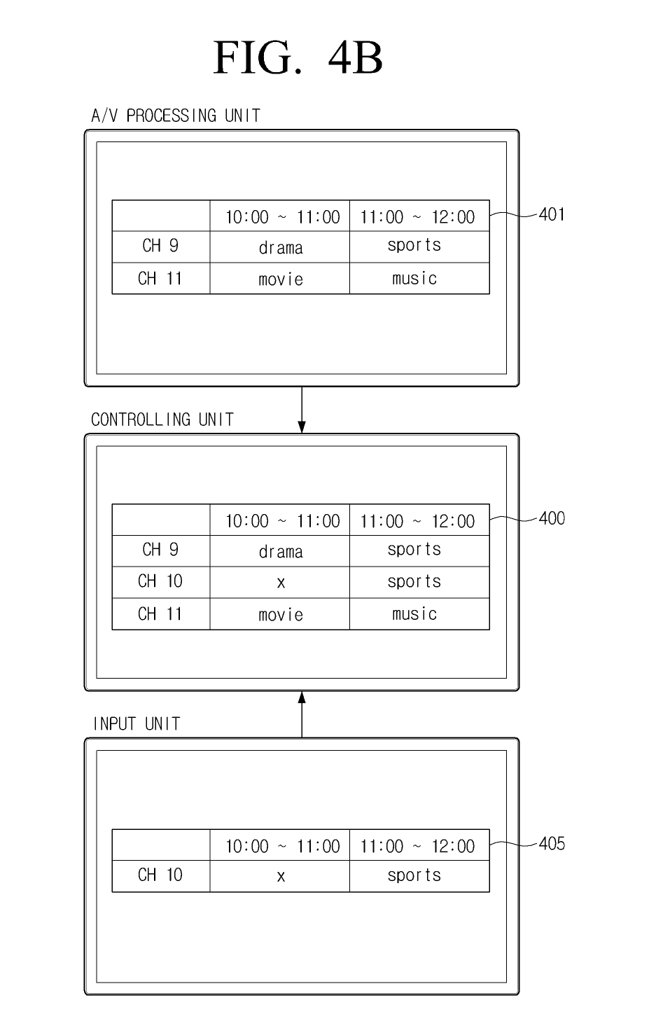

Herein below, an EPG having the edited broadcast time information will be explained with reference to FIGS. 4A and 4B.

FIGS. 4A and 4B are views showing an electronic program guide (EPG) to which information regarding broadcast time of an edited broadcast is added according to an exemplary embodiment of the present invention. FIG. 4A is a view showing an EPG to which broadcast time information of an edited broadcast is added, and FIG. 4B is a view showing the process of adding broadcast time information of an edited broadcast to an EPG.

Referring to FIG. 4A, an EPG 400 provides broadcast time information of three channels: CH 9, CH 10, and CH 11. Public broadcasts are broadcast over CH 9 and CH 11, and edited broadcasts are broadcast over CH 10. That is, information regarding CH 9 and CH 11 may be broadcast time information of channels over which public broadcasts are output, and information regarding CH 10 may be the broadcast time information of a channel over which the edited broadcast is output.

In FIG. 4A, the edited broadcast output over CH 10 may be the broadcast which is generated by editing the public broadcast output over CH 9. Accordingly, CH 9 and CH 10 output the same sport broadcast. The edited broadcast output over CH 10 may be the broadcast which is generated and output by editing the public broadcast output over CH 9 in real-time.

The DTV 100 receives broadcast time information of the public broadcast over CH 9 and CH 11 from each broadcasting station, adds broadcast time information of the edited broadcast output over CH 10 to the broadcast time information of the public broadcast, and generates the EPG 400 having broadcast time information of both the public broadcast and the edited broadcast.

Herein below, the process of generating the EPG 400 having the edited broadcast time information together with the public broadcast time information will be explained with reference to FIG. 4B.

Referring to FIG. 4B, the controlling unit 150 receives an EPG 401 having broadcast time information of the public broadcast 300 and edited broadcast time information 405 from the A/V processing unit 120 and the input unit 180.

Specifically, the controlling unit 150 receives the EPG 401 of the public broadcast through the A/V processing unit 120, and receives the edited broadcast time information 405 from the input unit 180.

The time at which the edited broadcast is output may be input through the input unit 180, and the channel over which the edited broadcast is output may be determined by the controlling unit 150. The controlling unit 150 determines the channels to output the public broadcast to be CH 9 and CH 11, and thus determines the channel to output the edited broadcast to be CH 10.

Accordingly, the controlling unit 150 regenerates the EPG 400 by combining the EPG 401 having broadcast time information of the public broadcast 300 and edited broadcast time information 405, and transmits the EPG 400 having the edited broadcast time information in addition to the public broadcast time information to users accessing the Internet through the network interface 160.

While the DTV 100 of a user providing an edited broadcast generates an EPG having the edited broadcast time information and transmits the generated EPG to viewers in this exemplary embodiment of the present invention, the DTV of a viewer viewing the edited broadcast may also generate an EPG having the edited broadcast time information.

If a user providing an edited broadcast transmits the edited broadcast time information to a viewer, the DTV of the viewer may generate an EPG having the edited broadcast time information by adding broadcast time information received from the user to an EPG of a public broadcast received from a broadcasting station.

The edited broadcast time information is added to the EPG having the public broadcast time information in this exemplary embodiment of the present invention, but information regarding the edited broadcast other than the edited broadcast time information may also be added. That is, various information about the edited broadcast such as the genre, editor, editing date, or editing scheme may be provided together with or separately from the edited broadcast time information.

The edited broadcast time information is added to the EPG having the public broadcast information and thus the EPG having the edited broadcast time information and the public broadcast time information is transmitted to viewers accessing the Internet in this exemplary embodiment of the present invention, but this is merely an exemplary embodiment of the present invention. The EPG having only the edited broadcast time information may be transmitted separately from the public broadcast time information. Accordingly, viewers accessing the Internet to view a private broadcast may view both a public broadcast received through a tuner and a private broadcast received via the Internet by changing channels.

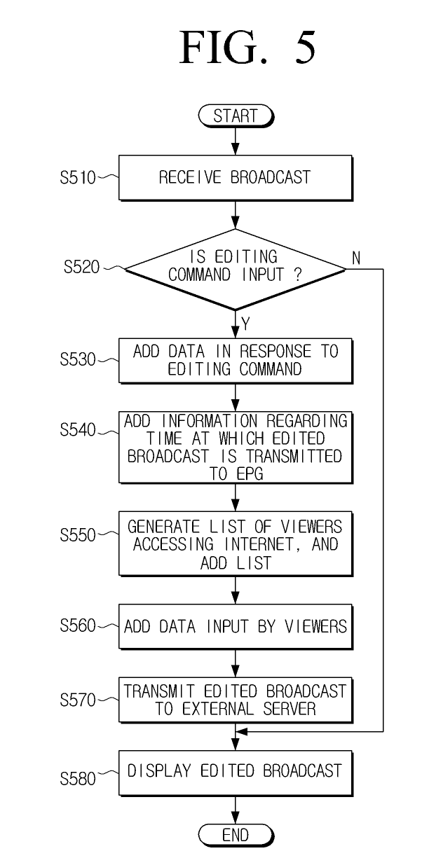

FIG. 5 is a flowchart provided to explain a method for providing an edited broadcast according to an exemplary embodiment of the present invention.

The DTV 100 receives a public broadcast from a broadcasting station through the broadcast reception unit 110 (S510). The DTV 100 determines whether a user inputs an editing command (S520). If it is determined that the editing command is input, the DTV 100 adds data to the public broadcast in response to the editing command (S530).

The DTV 100 adds to an EPG of the public broadcast the information regarding the time at which the edited broadcast is transmitted (S540).

The DTV 100 generates a list of viewers accessing the Internet to view the edited broadcast, adds the list to the public broadcast (S550), and adds data input by the viewers to the public broadcast (S560).

The DTV 100 transmits the edited broadcast having various data to the viewers accessing the Internet (S570), and displays the edited broadcast (S580).

The DTV 100 is provided as a DTV of a user who generates and provides the edited broadcast in this exemplary embodiment of the present invention, but this is merely an exemplary embodiment of the present invention. The present invention may also be applied to a situation in which the DTV 100 is provided as a DTV of a viewer who receives and views the edited broadcast.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A broadcast receiving apparatus comprising:
a broadcast reception unit which receives a received broadcast;
an input unit which receives an editing command for editing the received broadcast; and
a controlling unit which generates an edited broadcast by editing the received broadcast based on the editing command, and which transmits the edited broadcast to an external server via a network.

2. The broadcast receiving apparatus as claimed in claim 1,
wherein the edited broadcast is generated by adding editing data to the received broadcast.

3. The broadcast receiving apparatus as claimed in claim 2,
wherein the editing data comprises data generated before the received broadcast is received.

4. The broadcast receiving apparatus as claimed in claim 2,
wherein the editing data comprises data generated after the received broadcast is received.

5. The broadcast receiving apparatus as claimed in claim 2,
wherein the editing data comprises a list of users accessing the network
to view the edited broadcast.

6. The broadcast receiving apparatus as claimed in claim 2,
wherein the editing data comprises data input by users accessing the network to view the edited broadcast.

7. The broadcast receiving apparatus as claimed in claim 2,
wherein the editing data comprises at least one of video data, audio data, and text data.

8. The broadcast receiving apparatus as claimed in claim 1,
wherein the edited broadcast comprises at least one option corresponding to the received broadcast.

9. The broadcast receiving apparatus as claimed in claim 8,
wherein the at least one option comprises at least one of whether the received broadcast is publicly viewable, a limit in a number of viewers of the edited broadcast, and a time at which the edited broadcast is transmitted over the network.

10. The broadcast receiving apparatus as claimed in claim 1,
wherein the controlling unit adds information to an electronic program guide (EPG) which is received through the broadcast reception unit, the
information comprising a time at which the edited broadcast is transmitted, and
wherein the controlling unit transmits the EPG comprising the information to the external server.

11. The broadcast receiving apparatus as claimed in claim 3, further comprising:
a storage unit which stores at least one of the received broadcast data and the data generated before the received broadcast is received.

12. The broadcast receiving apparatus as claimed in claim 6, further comprising:
a storage unit which stores at least one of the received broadcast data and the data input by users accessing the network.

13. A broadcast receiving apparatus comprising:
a broadcast reception unit which receives a broadcast from a broadcasting station;
a network interface which receives an edited broadcast from an external server; and
a controlling unit which displays at least one of the received broadcast and the edited broadcast based on a command for selecting a channel.

14. The broadcast receiving apparatus as claimed in claim 13,
wherein the controlling unit allots the received broadcast to a first predetermined channel and the edited broadcast to a second predetermined channel, and outputs an output broadcast corresponding to a selected channel based on the command for selecting the channel.

15. The broadcast receiving apparatus as claimed in claim 13, further comprising:
a display which displays at least one of the received broadcast and the edited broadcast,
wherein the controlling unit adds information to an electronic program guide (EPG) which is received together with the received broadcast, information comprising a time at which the edited broadcast is transmitted, and
wherein the controlling unit displays the EPG comprising the information on the display.

16. A method for providing an edited broadcast using a broadcast receiving apparatus, the method comprising:
receiving a broadcast;
receiving a command for editing the received broadcast;
generating an edited broadcast by editing the received broadcast based on the editing command; and
transmitting the edited broadcast to an external server via a network.

17. The method as claimed in claim 16,
wherein generating the edited broadcast comprises adding editing data to the received broadcast.

18. The method as claimed in claim 16,
wherein the editing data comprise data generated before the broadcast is received.

19. The method as claimed in claim 16,
wherein the editing data comprises data generated after the broadcast is received.

20. The method as claimed in claim 16,
wherein the editing data comprises a list of users accessing the network to view the edited broadcast.

21. The method as claimed in claim 16,
wherein the editing data comprises data input by users accessing the network to view the edited broadcast.

22. The method as claimed in claim 16,
wherein the editing data comprises at least one of video data, audio data, and text data.

23. The method as claimed in claim 16,
wherein the edited broadcast comprises at least one option corresponding to the received broadcast.

24. The method as claimed in claim 23,
wherein the at least one option comprises at least one of whether the broadcast is publicly viewable, a limit in a number of viewers of the edited broadcast, and a time at which the edited broadcast is transmitted over the network.

25. The method as claimed in claim 16,
wherein the editing operation adds information to an electronic program guide (EPG) which is received together with the edited broadcast,
wherein the information comprising a time at which the edited broadcast is transmitted.

26. The method as claimed in claim 18, further comprising:
storing at least one of the received broadcast data and the data generated before the received broadcast is received.

27. The method as claimed in claim 21, further comprising:
storing at least one of the received broadcast data and the data input by users accessing the network.

28. A method for receiving edited broadcast using a broadcast receiving apparatus, the method comprising:
receiving a received broadcast from a broadcasting station;
receiving an edited broadcast from an external server through a network;
receiving a command for selecting a channel; and
outputting at least one of the received broadcast and the edited broadcast based on the command for selecting the channel.

29. The method as claimed in claim 28, further comprising:
allotting the received broadcast to a first predetermined channel;
allotting the edited broadcast to a second predetermined channel; and
receiving the command for selecting the channel,
wherein the outputting comprises outputting an output broadcast corresponding to the selected channel based on the command for selecting the channel.

30. The method as claimed in claim 28, further comprising:
if a command for outputting an electronic program guide (EPG) is received, adding information to the EPG received together with the received broadcast,
wherein the information comprises a time at which the edited broadcast is transmitted.

31. A method of personalizing a broadcast, the method comprising:
receiving a first broadcast;
receiving a user input for adding content to the first broadcast or modifying the first broadcast;
generating a second broadcast in accordance with the user input;
transmitting the second broadcast to an external server via a network.

32. The method of claim 31, wherein the received user input comprises user generated content.

33. The method of claim 32, wherein the received user input for adding content to the first broadcast comprises adding at least one of audio content, video content and text content.

34. The method of claim 32, wherein the received user input for modifying the first broadcast comprises modifying at least one of audio content, video content and text content of the first broadcast.
